(19) United States
(12) Patent Application Publication
(10) Pub. No.: US 2016/0104263 A1
(43) Pub. Date: Apr. 14, 2016

(54) Method And Apparatus Of Latency Profiling Mechanism

(71) Applicant: Media Tek Inc., Hsinchu (TW)

(72) Inventors: Yi-Cheng Chen, Taichung (TW); Yi Hsuan Lin, I, Hsinchu (TW); Kun-Hao Liu, New Taipei City (TW)

(21) Appl. No.: 14/806,656

(22) Filed: Jul. 23, 2015

Related U.S. Application Data
(60) Provisional application No. 62/061,839, filed on Oct. 9, 2014.

(51) Int. Cl. G06T 1/20

(52) U.S. Cl. CPC G06T 1/20

(57) ABSTRACT

Techniques related to a latency profiling mechanism are described. A method may monitor at least one attribute associated with each of one or more frames of images by tracking a respective identifier of each of the one or more frames as each of the one or more frames is processed through a first pipeline of one or more processing stages of an image processing device. The method may also obtain one or more indications related to one or more performance indices in the first pipeline of one or more processing stages based at least in part on the monitoring of the at least one attribute.

### CROSS REFERENCE TO RELATED PATENT APPLICATION

The present disclosure is a non-provisional patent application claiming the priority benefit of U.S. Provisional Patent Application No. 62/061,839 filed on 9 Oct. 2014, which is incorporated by reference in its entirety.

### TECHNICAL FIELD

The present disclosure is generally related to latency profiling and, more particularly, to method and apparatus of a latency profiling mechanism.

### BACKGROUND

Unless otherwise indicated herein, approaches described in this section are not prior art to the claims listed below and are not admitted to be prior art by inclusion in this section.

When data, whether transmitted in frames or packets, is processed through two (or more) different pipelines each of which having one or more processing stages, the time that one pipeline finishes processing the data may be different from the time that another pipeline finishes processing that data. The difference in time between the two pipelines in processing the same data is referred to as latency. However, the latency between the two pipelines may not necessarily remain constant and, rather, may vary (e.g., increase or decrease) for one reason or another such as performance degradation or abnormality that occurs in any number of the processing stages in the pipelines.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve monitoring at least one attribute associated with each of one or more frames of images by tracking a respective identifier of each of the one or more frames as each of the one or more frames is processed through a first pipeline of one or more processing stages of an image processing device. The method may also involve obtaining one or more indications related to one or more performance indices in the first pipeline of one or more processing stages based at least in part on the monitoring of the at least one attribute.

In another example implementation, a method may involve assigning a respective identifier to each of one or more frames of a plurality of frames of images. The method may also involve recording a starting time and an ending time of processing of each of the one or more frames as each of the one or more frames is processed through a pipeline of one or more processing stages of an image processing device. The method may further involve obtaining one or more indications of a per-stage latency for each processing stage of the pipeline of one or more processing stages.

In yet another example implementation, a device may include a memory unit and a processing unit. The memory unit may be configured to store data therein. The processing unit may be coupled to the plurality of processing modules and the memory unit. The processing unit may be configured to monitor at least one attribute associated with each of the one or more frames by tracking a respective identifier of each of the one or more frames as each of the one or more frames is processed through a first pipeline of one or more processing stages. The processing unit may also be configured to obtain one or more indications related to one or more performance indices in the first pipeline of one or more processing stages based at least in part on a result of the monitoring.

In still another example implementation, a device may include a memory unit and a processing unit. The memory unit may be configured to store data therein. The processing unit may be coupled to the plurality of processing modules and the memory unit. The processing unit may be configured to assign a respective identifier to each of the one or more frames. The processing unit may also be configured to store, in the memory unit, data of a starting time and an ending time of processing of the one or more frames for each processing stage of a pipeline of one or more processing stages. The processing unit may further be configured to receive an indication that there is a condition related to one or more performance indices in the pipeline.

The proposed latency profiling mechanism, whether implemented as a method or an apparatus, provides insight to per-stage latency of a pipeline of processing stages. That is, the proposed latency profiling mechanism allows a bird's eye view over each processing stage of a given pipeline and enables analysis of latency to identify one or more issues associated with one or more processing stages of a pipeline. Moreover, based on the identified latency, a signal or interrupt may be sent to notify one or more processing stages to accelerate for overdrive or to decelerate for voltage frequency scaling. Advantageously, a device may remain in a low-power state as usual while keeping high-performance operation(s) if necessary. Moreover, results of the latency profiling may be used as performance indices to improve the design of processing modules in the future.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example framework in which various implementations in accordance with the present disclosure may be implemented.

FIG. 2 is a diagram showing an example scenario of monitoring of latency between different pipelines of processing stages in accordance with an implementation of the present disclosure.

FIG. 3 is a block diagram of an example apparatus in accordance with an implementations of the present disclosure.

FIG. 4 is a block diagram of an example apparatus in accordance with another implementations of the present disclosure.

FIG. 5 is a flowchart of an example process in accordance with an implementation of the present disclosure.

FIG. 6 is a flowchart of an example process in accordance with another implementation of the present disclosure.

### DETAILED DESCRIPTION OF PREFERRED EMBODIMENTS

### Overview

For better appreciation of the benefits and advantages of techniques, mechanisms, methods, devices, apparatuses and systems according to the present disclosure, detailed description of various implementations, or implementations, is provided in the context of Wi-Fi display (hereinafter referred to as “WFD”). However, those skilled in the art would appreciate that the inventive concepts described herein may be utilized in any other suitable context and/or application. For example, the inventive concepts described herein may be utilized in any wireless or wired communication, not limited to Wi-Fi, and/or any types of display devices or electronic devices.

In the context of WFD, in which the same multimedia content (e.g., video) may be displayed, played or otherwise presented by a source device (e.g., a smartphone) and streamed via Wi-Fi to a sink device (e.g., a television) to be displayed, played or otherwise presented by the sink device, the concept of WFD latency refers to a difference in time in displaying, playing or otherwise presenting the same multimedia content between the two devices after the multimedia content is processed by two pipelines of processing stages. Using video content as an example, data of the video content may be propagated through one pipeline of one or more processing stages to be displayed on the source device and through another pipeline of one or more processing stages to be displayed on the sink device.

Given the difference between the amounts of processing time through the two pipelines, the same video content may be displayed on the source device at a first point in time and displayed on the sink device at a second point in time different from the first point in time. The difference between the first point in time and the second point in time is the WFD latency. The WFD latency between the two pipelines may not necessarily be fixed as it may vary (e.g., increase or decrease) for one reason or another such as performance degradation or abnormality that occurs in one of the pipelines, for example.

For a vendor that provides a device having above-described pipelines, at least from the perspective of quality assurance (QA) staff as well as research and development (RD) staff of the vendor, it may be necessary to identify cause(s) of the variation in WFD latency between the two pipelines in order to troubleshoot and/or improve the design of one or more processing stages of the pipelines. Often time, though, what the vendor may be able to display is merely a portion of each pipeline in concern from user space to kernel space, and it is hard to gain an overview of the overall WFD latency.

Advantageously, implementations of the present disclosure utilize a systematic, uniform profiling mechanism believed to ease efforts in the evaluation of WFD latency for QA and RD. Under the latency profiling mechanism in accordance with the present disclosure, each frame may be embedded with a unique token, which is passed across processes/threads as well as across user/kernel space drivers. Moreover, each processing stage or module of a given pipeline may define its own stage, e.g., each processing stage may be profiled with trace points added. The profiling data may then be collected from each processing stage and processed to provide numerical and/or graphical information for analysis, display, report generation and/or other purposes. For example, profiling results may be provided to a latency monitor, which may be either a software or processing module implemented on-chip or off-chip, for the latency monitor to analyze the collected information, e.g., a starting time and an ending time in processing a given frame at each processing stage, to determine per-stage latency of a pipeline, e.g., a display pipeline for WFD. With the per-stage latency known, the latency monitor may send a signal/interrupt to notify one or more processing stages or modules to accelerate, e.g., for overdrive, or to decelerate, e.g., for voltage frequency scaling. Accordingly, a device may remain in a low-power state as usual while keeping high-performance operation(s) if necessary. Moreover, results of the latency profiling may be used as performance indices to improve the design of processing modules in the future.

Utilizing implementation(s) of the latency profiling mechanism of the present disclosure, QA staff may be able to troubleshoot according to a report of the latency profiling mechanism. Moreover, RD staff may be able to have a bird's-eye view of an entire pipeline as well as each processing stage thereof, and this would aid the analysis of latency issues more efficiently. Furthermore, the profiling results may be used as a post-silicon performance index by a hardware designer in improving the hardware design of one or more processing stages/modules of a given pipeline.

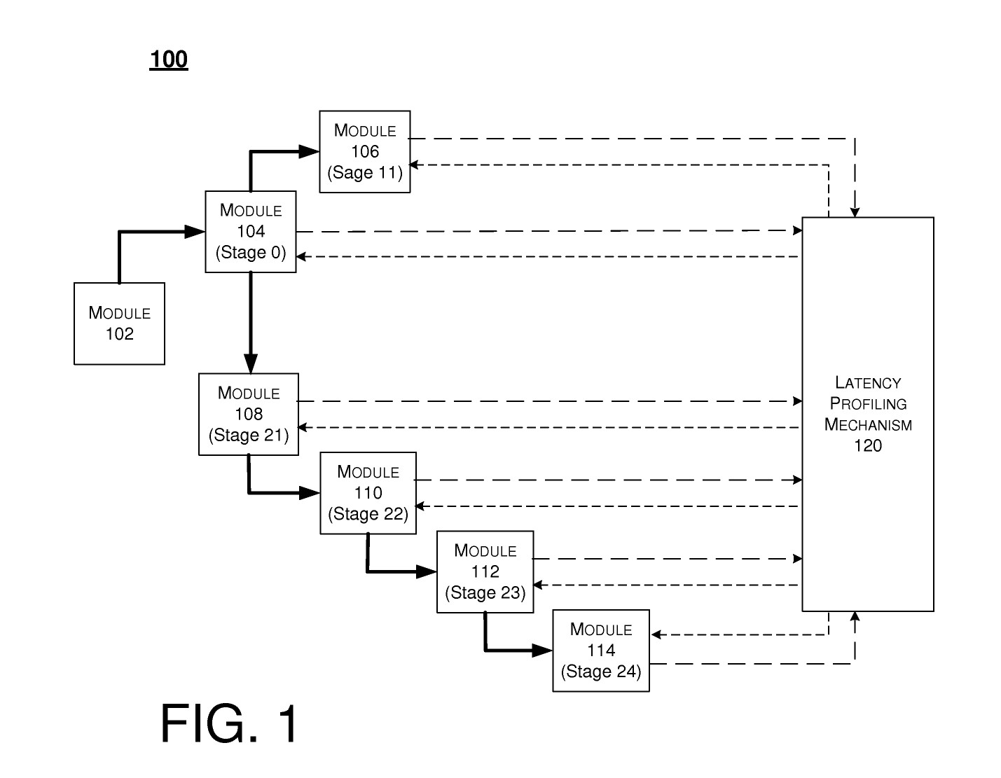

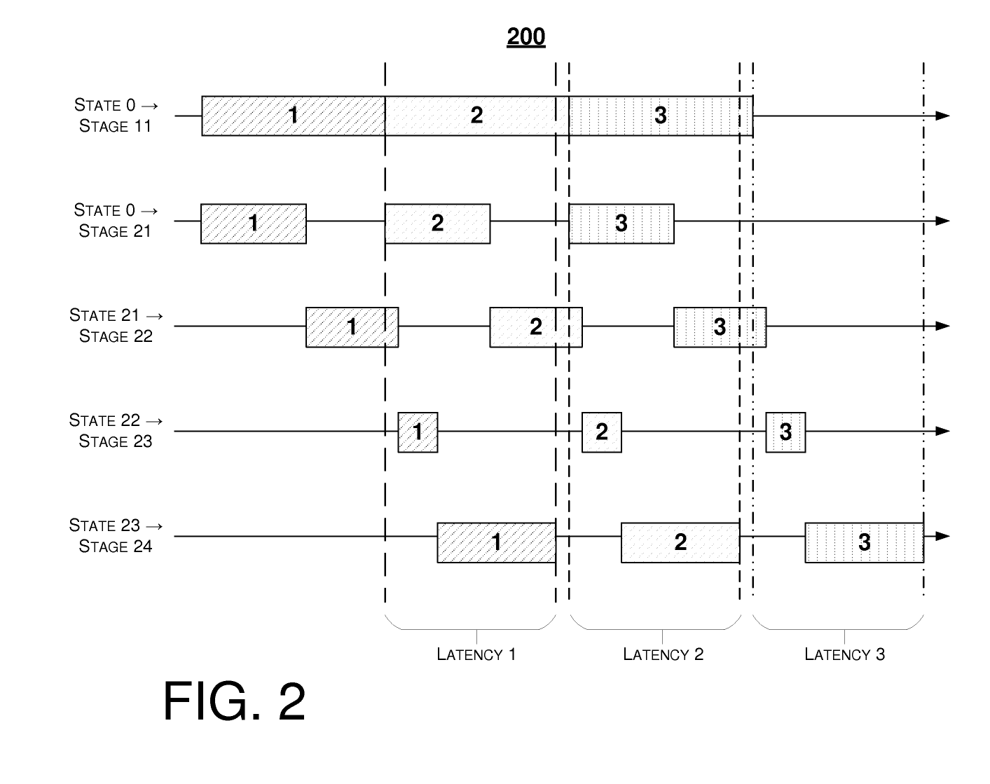

FIG. 1 illustrates an example framework 100 in which various implementations in accordance with the present disclosure may be implemented. FIG. 2 illustrates an example scenario 200 of monitoring of latency between different pipelines of processing stages in accordance with an implementation of the present disclosure. The following description is provided with reference to both FIG. 1 and FIG. 2.

Referring to FIG. 1, example framework 100 may include processing modules configured to implement algorithms, processes and/or operations related to WFD, which may be implemented in an image processing device or an electronic device. For instance, the processing modules in example framework 100 may include processing modules 102, 104, 106, 108, 110, 112 and 114. For example, processing modules 102, 104, 106, 108, 110, 112 and 114 may be multimedia processing modules configured to process multimedia frames, e.g., frames of image-related data such as images or video content. Each of processing modules 102, 104, 106, 108, 110, 112 and 114 may be implemented as a hardware module, a software module, a firmware module, a middleware module, or a combination thereof. Moreover, in implementations where the processing module is implemented as a hardware module, the hardware module may include circuits, e.g., integrated circuit (IC), made of transistors, resistors and any other electronic components configured to perform respective operation(s) that the respective processing module is designed to perform. Moreover, the hardware module may also include firmware, middleware and/or software executed by the respective hardware circuit to perform the respective operation(s).

In example framework 100, modules 104 and 106 may form a first pipeline of processing stages, with each of modules 104 and 106 functioning as a respective processing stage. That is, modules 104 and 106 may form processing stage 0 and processing stage 11, respectively. Similarly, modules 108, 110, 112 and 114 may form a second pipeline of processing stages, with each of modules 108, 110, 112 and 114 functioning as a respective processing stage. That is, modules 108, 110, 112 and 114 may form processing stage 21, processing stage 22, processing stage 23 and processing stage 24, respectively.

In an example scenario of WFD, the first pipeline of processing stages (processing stages 0 and 11) may process one or more frames of a plurality of frames of images for display on a source device, which may be a mobile device such as a smartphone. The second pipeline of processing stages (processing stages 0, 21, 22, 23 and 24) may process the same one or more frames for display on a sink device, which may be a television that is wirelessly coupled to the source device via Wi-Fi.

In the example scenario shown in FIG. 1, processing module 102 may be an image/video producer in the source device. For example, processing module 102 may include or implemented with SurfaceFlinger in an Android system, configured to composite application and system layers and displaying them. Processing modules 104 and 106 may include display modules for executing the displaying in the source device. For example, the display modules may include or be implanted with one or more Graphics Processing Units (GPUs), Overlay engine (OVL), and other component in a display subsystem. On the other hand, modules 108-114 may be configured to generate one or more duplicate frames with the same contents as the one or more frames to be displayed by the module 106. For example, modules 108-114 may include one or more mirroring modules configured to mirror contents of frames/images generated by the processing modules 104 and 106 (e.g., an output from OVL), one or more encoding modules configured to encode the mirroring result, and one or more wireless transmission modules which are configured to transmit the encoded frames/images and may include a Wi-Fi service module and a Wi-Fi driver module. Additionally, modules 108-114 may be all implemented in the source device.

Each processing stage of the first and second pipelines may perform a respective function different from that of the other processing stages. Accordingly, the amount of time for a given processing stage to process a given amount of data, e.g., a frame of image-related data, may differ from one processing stage to another processing stage.

Referring to FIG. 2, in example scenario 200, a number of frames such as frame 1, frame 2 and frame 3 are processed by the two pipelines of processing stages. The first pipeline, including processing stages 0 and 11, takes a certain amount of time to process each of frames 1, 2 and 3. Similarly, the second pipeline, including processing stages 0, 21, 22, 23 and 24, takes a certain amount of time to process each of frames 1, 2 and 3. Moreover, the processing times for processing a given frame are different among processing stages 0, 21, 22, 23 and 24 of the second pipeline. There is a difference in time between the time the first pipeline finishes processing a given frame and the time the second pipeline finishes processing the same frame. As shown in FIG. 2, the difference in time for processing frame 1 between the first pipeline and the second pipeline is labeled as latency 1, the difference in time for processing frame 2 between the first pipeline and the second pipeline is labeled as latency 2, and the difference in time for processing frame 3 between the first pipeline and the second pipeline is labeled as latency 3.

Referring to FIG. 1, each processing stage of the first and second pipelines may be configured to report to a latency profiling mechanism 120 certain information related to the processing of a given frame such as, for example, one or more attributes associated with the given frame. That is, latency profiling mechanism 120 may be configured to monitor at least one attribute associated with each of one or more frames of images, e.g., frames 1, 2 and 3. For instance, latency profiling mechanism 120 may do so by tracking a respective identifier of each of the one or more frames as each of the one or more frames is processed through the first pipeline of an image processing device. This may be done, for example, by each of the processing stages sending (1) a respective timestamp paired with the respective identifier of each of the one or more frames, (2) a respective checksum value which varies after being processed by each processing stage, or (3) both of the above.

Additionally, latency profiling mechanism 120 may monitor at least one attribute associated with a respective duplicate frame of each of the one or more frames by tracking a respective identifier of the respective duplicate frame as the respective duplicate frame is processed through the second pipeline of the image processing device. Latency profiling mechanism 120 may also obtain one or more indications related to one or more performance indices in each of the first and second pipelines based at least in part on the monitoring of the one or more attributes. Moreover, results of any, some or all of the operations of latency profiling mechanism 120, e.g., from the monitoring operation and/or the obtaining operation, may be provided to a display device which displays the results.

Latency profiling mechanism 120 may be configured to determine whether there is a condition related to the one or more performance indices in either or both of the first pipeline and the second pipeline. The condition may include (1) a fluctuation in frame rate through the one or more processing stages of the first pipeline, (2) an increase in processing time through the one or more processing stages of the first pipeline, or (3) both of the above. Furthermore, latency profiling mechanism 120 may also be configured to adjust at least one processing stage of the first pipeline and/or the second pipeline in response to determining that there is the condition related to the one or more performance indices in the first pipeline and/or the second pipeline. For instance, as shown in FIG. 1, latency profiling mechanism 120 may send a signal to any of the processing stages to accelerate or decelerate the processing stage that is being adjusted.

Additionally or alternatively, latency profiling mechanism 120 may be configured to embed the respective identifier in metadata associated with each of the one or more frames.

In monitoring the attribute(s) associated with each of the one or more frames, latency profiling mechanism 120 may obtain different values of the attribute(s) respectively corresponding to the different stages of the one or more processing stages of the respective pipeline. The respective timestamp paired with the respective identifier of each of the one or more frames may indicate, for example, a starting time and an ending time of processing of a respective frame by each processing stage. The one or more performance indices may include, for example, a per-stage latency for each processing stage of the respective pipeline.

Latency profiling mechanism 120 may accomplish the above by performing a number of operations. For instance, latency profiling mechanism 120 may assign a respective identifier to each of the one or more frames of images. Latency profiling mechanism 120 may also record a starting time and an ending time of processing of each of the one or more frames as each of the one or more frames is processed through the first pipeline and the second pipeline. Latency profiling mechanism 120 may further obtain one or more indications of a per-stage latency for each processing stage of the pipeline of one or more processing stages. Additionally, latency profiling mechanism 120 may determine whether there is a condition related to the per-stage latency for at least one processing stage of the pipeline of one or more processing stages. Such determined condition may include, for example, (1) a fluctuation in frame rate through the one or more processing stages of the pipeline, (2) an increase in processing time through the one or more processing stages of the pipeline, or (3) both of the above.

### Example Implementations

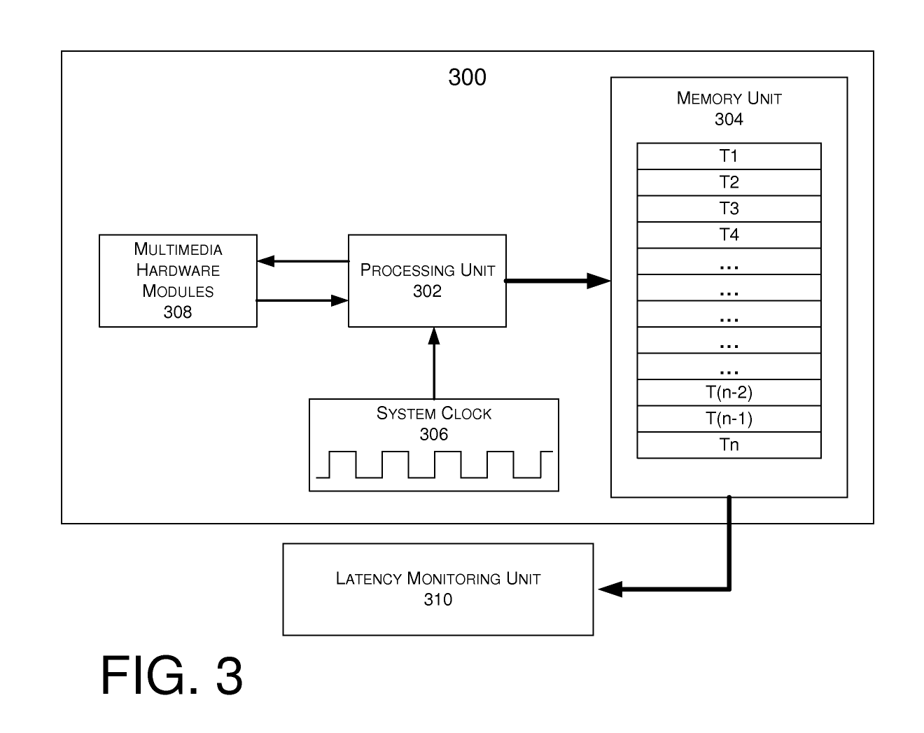

FIG. 3 is a block diagram of an example apparatus 300 in accordance with an implementation of the present disclosure. Example apparatus 300 may perform various functions related to techniques, methods and systems described herein, including example processes 500 and 600 described below. Example apparatus 300 may be implemented as latency profiling mechanism 120 in example framework 100. In some implementations, example apparatus 300 may be a portable electronics apparatus such as, for example, a smartphone, a portable electronic device or a computing device such as a tablet computer, a laptop computer, a notebook computer, a wearable device or the like, which is equipped with an image processing device.

Example apparatus 300 may include at least those components shown in FIG. 3, such as a processing unit 302, a memory unit 304, a system clock 306 and a number of multimedia processing modules 308. Although processing unit 302, memory unit 304, system clock 306 and multimedia processing modules 308 are illustrated as discrete components separate from each other, in various implementations of example apparatus 300 at least some of these components may be integral parts of a single IC, chip or chipset.

Memory unit 304 may be a random access memory (RAM) or any suitable memory device configured to store data therein.

Multimedia processing modules 308 may, similar to processing modules 102, 104, 106, 108, 110, 112 and 114 of example framework 100, form a first pipeline of one or more processing stages and a second pipeline of one or more processing stages, with each multimedia processing module 308 functioning as a respective processing stage. For instance, in the context of WFD, multimedia processing modules 308 form a first pipeline of one or more processing stages to process one or more frames of images to be displayed by a source device as well as a second pipeline of one or more processing stages to process the same one or more frames of images to be streamed via Wi-Fi to a sink device to be displayed by the sink device.

Processing unit 302 may be communicatively coupled to memory unit 304, system clock 306 and each of the multimedia processing modules 308. In particular, processing unit 302 may receive, from system clock 306, a clock signal indicative of time. Processing unit 302 may receive data from each of the multimedia processing modules 308 and store such data in memory unit 304. For instance, processing unit 302 may receive, from each of the multimedia processing modules 308, data related to a starting time and an ending time associated with processing a given frame by the respective multimedia processing module, and processing unit 302 may store such data in memory unit 304. Referring to FIG. 3, the data stored in memory unit 304 is shown as time points T1, T2, T3, T4 . . . T(n−2), T(n−1) and Tn to indicate different points in time as the starting times and ending times associated with the processing of one or more frames by each of the multimedia processing modules 308. Based on the data stored in memory unit 304, processing unit 302 (or an external latency monitoring unit 310 to be described below) may calculate or otherwise determine the latency in each processing stage as well as an entire pipeline of one or more processing stages.

In some implementations, processing unit 302 may be configured to monitor at least one attribute associated with each of the one or more frames. Processing unit 302 may accomplish this by, for example, tracking a respective identifier of each of the one or more frames as each of the one or more frames is processed through the first pipeline. Processing unit 302 may also be configured to obtain one or more indications related to one or more performance indices in the first pipeline based at least in part on a result of the monitoring.

In some implementations, in monitoring the at least one attribute associated with the one or more frames, processing unit 302 may be configured to obtain different values of the at least one attribute respectively corresponding to the different stages of the one or more processing stages of the first pipeline.

In some implementations, processing unit 302 may be further configured to monitor at least one attribute associated with a respective duplicate frame of each of the one or more frames by tracking a respective identifier of the respective duplicate frame as the respective duplicate frame is processed through the second pipeline.

In some implementations, the at least one attribute associated with each of the one or more frames may include a respective timestamp paired with the respective identifier of each of the one or more frames, a respective checksum value which varies after being processed by each processing stage, or both. In some implementations, the respective timestamp paired with the respective identifier of each of the one or more frames may indicate a starting time and an ending time of processing of a respective frame.

In some implementations, the one or more performance indices in the first pipeline may include a per-stage latency for each processing stage of the one or more processing stages of the first pipeline.

In some implementations, processing unit 302 may be further configured to embed the respective identifier in metadata associated with each of the one or more frames.

In some implementations, processing unit 302 may be configured to determine whether there is a condition related to the one or more performance indices in the first pipeline. Additionally, processing unit 302 may also be configured to adjust at least one processing stage of the one or more processing stages of the first pipeline in response to determining that there is the condition related to the one or more performance indices in the first pipeline. For instance, processing unit 302 may send a signal to any of the processing stages to accelerate or decelerate the processing stage that is being adjusted. In some implementations, the condition related to the one or more performance indices in the first pipeline may include a fluctuation in frame rate through the one or more processing stages of the first pipeline, an increase in processing time through the one or more processing stages of the first pipeline, or both.

In some implementations, processing unit 302 may be configured to assign a respective identifier to each of one or more frames of images. Processing unit 302 may also be configured to store, in memory unit 304, data of a starting time and an ending time of processing of the one or more frames for each processing stage of the first pipeline and the second pipeline formed by the processing modules. Processing unit 302 may further be configured to receive an indication that there is a condition related to one or more performance indices in the pipeline and/or the second pipeline.

In the configuration described above, in which processing unit 302, memory unit 304, system clock 306 and multimedia processing modules 308 are disposed within a boundary, perimeter, housing, casing or enclosure of apparatus 400, processing unit 302, memory unit 304 and system clock 306 together perform functions similar or identical to those of latency profiling mechanism 120 of example framework 100.

Alternatively, in another configuration, apparatus 300 may also include latency monitoring unit 310 which is external to the boundary, perimeter, housing, casing or enclosure in which processing unit 302, memory unit 304 and system clock 306 are disposed. Memory unit 304 may be communicatively coupled to latency monitoring unit 310, e.g., through a universal serial bus (USB) port or any suitable communication port. With latency monitoring unit 310, at least some of the functions of latency profiling mechanism 120 of example framework 100 may be performed by latency monitoring unit 310. For example, latency monitoring unit 310 may be configured to determine whether there is a condition related to the one or more performance indices in the first pipeline and/or the second pipeline.

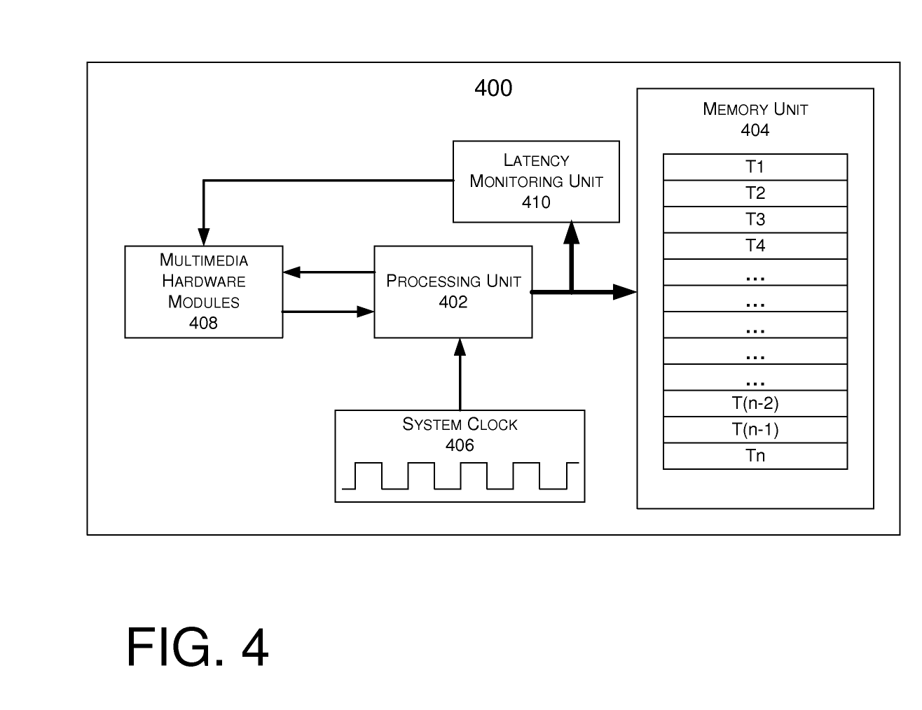

FIG. 4 is a block diagram of an example apparatus 400 in accordance with another implementation of the present disclosure. Example apparatus 400 may perform various functions related to techniques, methods and systems described herein, including example processes 500 and 600 described below. Example apparatus 400 may be implemented as latency profiling mechanism 120 in example framework 100. In some implementations, example apparatus 400 may be a portable electronics apparatus such as, for example, a smartphone, a portable electronic device or a computing device such as a tablet computer, a laptop computer, a notebook computer, a wearable device or the like, which is equipped with an image processing device.

Example apparatus 400 may include at least those components shown in FIG. 4, such as a processing unit 402, a memory unit 404, a system clock 406, a number of multimedia processing modules 408 and a latency monitoring unit 410. Although processing unit 402, memory unit 404, system clock 406, multimedia processing modules 408 and latency monitoring unit 410 are illustrated as discrete components separate from each other, in various implementations of example apparatus 400 at least some of these components may be integral parts of a single IC, chip or chipset.

In the configuration shown in FIG. 4, processing unit 402, memory unit 404, system clock 406, multimedia processing modules 408 and latency monitoring unit 410 are disposed within a boundary, perimeter, housing, casing or enclosure of apparatus 400. In some implementations, processing unit 402, memory unit 404, system clock 406 and latency monitoring unit 410 together perform functions similar or identical to those of latency profiling mechanism 120 of example framework 100.

Memory unit 404 may be a random access memory (RAM) or any suitable memory device configured to store data therein.

Multimedia processing modules 408 may, similar to processing modules 102, 104, 106, 108, 110, 112 and 114 of example framework 100, form a first pipeline of one or more processing stages and a second pipeline of one or more processing stages, with each multimedia processing module 408 functioning as a respective processing stage. For instance, in the context of WFD, multimedia processing modules 408 form a first pipeline of one or more processing stages to process one or more frames of images to be displayed by a source device as well as a second pipeline of one or more processing stages to process the same one or more frames of images to be streamed via Wi-Fi to a sink device to be displayed by the sink device.

Processing unit 402 may be communicatively coupled to memory unit 404, system clock 406, each of the multimedia processing modules 408 and latency monitoring unit 410. In particular, processing unit 402 may receive, from system clock 406, a clock signal indicative of time. Processing unit 402 may receive data from each of the multimedia processing modules 408 and store such data in memory unit 404. For instance, processing unit 402 may receive, from each of the multimedia processing modules 408, data related to a starting time and an ending time associated with processing a given frame by the respective multimedia processing module, and processing unit 402 may store such data in memory unit 404. Referring to FIG. 4, the data stored in memory unit 404 is shown as time points T1, T2, T3, T4 . . . T(n−2), T(n−1) and Tn to indicate different points in time as the starting times and ending times associated with the processing of one or more frames by each of the multimedia processing modules 408. Based on the data stored in memory unit 404, latency monitoring unit 410 may calculate or otherwise determine the latency in each processing stage as well as an entire pipeline of one or more processing stages.

In some implementations, latency monitoring unit 410 may be configured to monitor at least one attribute associated with each of the one or more frames. Latency monitoring unit 410 may accomplish this by, for example, tracking a respective identifier of each of the one or more frames as each of the one or more frames is processed through the first pipeline. Latency monitoring unit 410 may also be configured to obtain one or more indications related to one or more performance indices in the first pipeline based at least in part on a result of the monitoring.

In some implementations, in monitoring the at least one attribute associated with the one or more frames, latency monitoring unit 410 may be configured to obtain different values of the at least one attribute respectively corresponding to the different stages of the one or more processing stages of the first pipeline.

In some implementations, latency monitoring unit 410 may be further configured to monitor at least one attribute associated with a respective duplicate frame of each of the one or more frames by tracking a respective identifier of the respective duplicate frame as the respective duplicate frame is processed through the second pipeline.

In some implementations, the at least one attribute associated with each of the one or more frames may include a respective timestamp paired with the respective identifier of each of the one or more frames, a respective checksum value which varies after being processed by each processing stage, or both. In some implementations, the respective timestamp paired with the respective identifier of each of the one or more frames may indicate a starting time and an ending time of processing of a respective frame.

In some implementations, the one or more performance indices in the first pipeline may include a per-stage latency for each processing stage of the one or more processing stages of the first pipeline.

In some implementations, latency monitoring unit 410 may be further configured to embed the respective identifier in metadata associated with each of the one or more frames.

In some implementations, latency monitoring unit 410 may be configured to determine whether there is a condition related to the one or more performance indices in the first pipeline. Additionally, latency monitoring unit 410 may also be configured to adjust at least one processing stage of the one or more processing stages of the first pipeline in response to determining that there is the condition related to the one or more performance indices in the first pipeline. For instance, latency monitoring unit 410 may send a signal to any of the processing stages to accelerate or decelerate the processing stage that is being adjusted. In some implementations, the condition related to the one or more performance indices in the first pipeline may include a fluctuation in frame rate through the one or more processing stages of the first pipeline, an increase in processing time through the one or more processing stages of the first pipeline, or both.

In some implementations, processing unit 402 may be configured to assign a respective identifier to each of one or more frames of images. Processing unit 402 may also be configured to store, in memory unit 404, data of a starting time and an ending time of processing of the one or more frames for each processing stage of a given pipeline of one or more processing stages formed by the processing modules. Processing unit 402 may further be configured to receive an indication that there is a condition related to one or more performance indices in the pipeline.

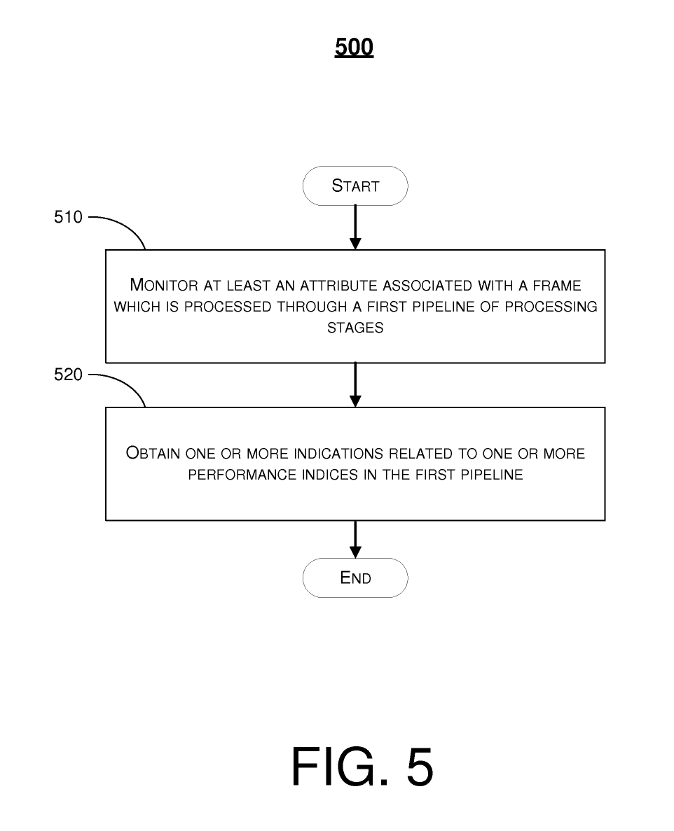

FIG. 5 is a flowchart of an example process 500 in accordance with an implementation of the present disclosure. Example process 500 may include one or more operations, actions, or functions as represented by one or more of blocks 510 and 520. Although illustrated as discrete blocks, various blocks may be divided into additional blocks, combined into fewer blocks, or eliminated, depending on the desired implementation. Example process 500 may be implemented by latency profiling mechanism 120 of example framework 100, one or more components of example apparatus 300, and/or or one or more components of example apparatus 400. For illustrative purposes, the operations described below are performed by latency profiling mechanism 120 of example framework 100. Example process 500 may begin at block 510.

Block 510 (Monitor at least an attribute associated with a frame which is processed through a first pipeline of processing stages) may refer to latency profiling mechanism 120 monitoring at least one attribute associated with each of one or more frames of images by tracking a respective identifier of each of the one or more frames as each of the one or more frames is processed through a first pipeline of one or more processing stages of an image processing device.

Block 520 (Obtain one or more indications related to one or more performance indices in the first pipeline) may refer to latency profiling mechanism 120 obtaining one or more indications related to one or more performance indices in the first pipeline of one or more processing stages based at least in part on the monitoring of the at least one attribute.

In some implementations, in monitoring the at least one attribute associated with the one or more frames, example process 500 may involve latency profiling mechanism 120 obtaining different values of the at least one attribute respectively corresponding to the different stages of the one or more processing stages of the first pipeline.

In some implementations, example process 300 may further involve latency profiling mechanism 120 monitoring at least one attribute associated with a respective duplicate frame of each of the one or more frames by tracking a respective identifier of the respective duplicate frame as the respective duplicate frame is processed through a second pipeline of one or more processing stages of the image processing device.

In some implementations, the at least one attribute associated with each of the one or more frames may include a respective timestamp paired with the respective identifier of each of the one or more frames, a respective checksum value which varies after being processed by each processing stage, or both. In some implementations, the respective timestamp paired with the respective identifier of each of the one or more frames may indicate a starting time and an ending time of processing of a respective frame.

In some implementations, the one or more performance indices in the first pipeline of one or more processing stages may include a per-stage latency for each processing stage of the one or more processing stages of the first pipeline.

In some implementations, example process 500 may further involve latency profiling mechanism 120 embedding the respective identifier in metadata associated with each of the one or more frames.

Additionally or alternatively, example process 500 may involve latency profiling mechanism 120 determining whether there is a condition related to the one or more performance indices in the first pipeline of one or more processing stages. In some implementations, the condition related to the one or more performance indices in the first pipeline of one or more processing stages may include a fluctuation in frame rate through the one or more processing stages of the first pipeline, an increase in processing time through the one or more processing stages of the first pipeline, or both. In some implementations, example process 500 may further involve latency profiling mechanism 120 adjusting at least one processing stage of the one or more processing stages of the first pipeline in response to determining that there is the condition related to the one or more performance indices in the first pipeline of one or more processing stages.

In some implementations, example process 500 may further involve latency profiling mechanism 120 providing data of one or more results of the monitoring, the obtaining, or both the monitoring and the obtaining to a display device which displays the one or more results. Additionally or alternatively, example process 500 may also involve latency profiling mechanism 120 providing data of one or more results of at least one of the monitoring, the obtaining, or the determining to a display device which displays the one or more results.

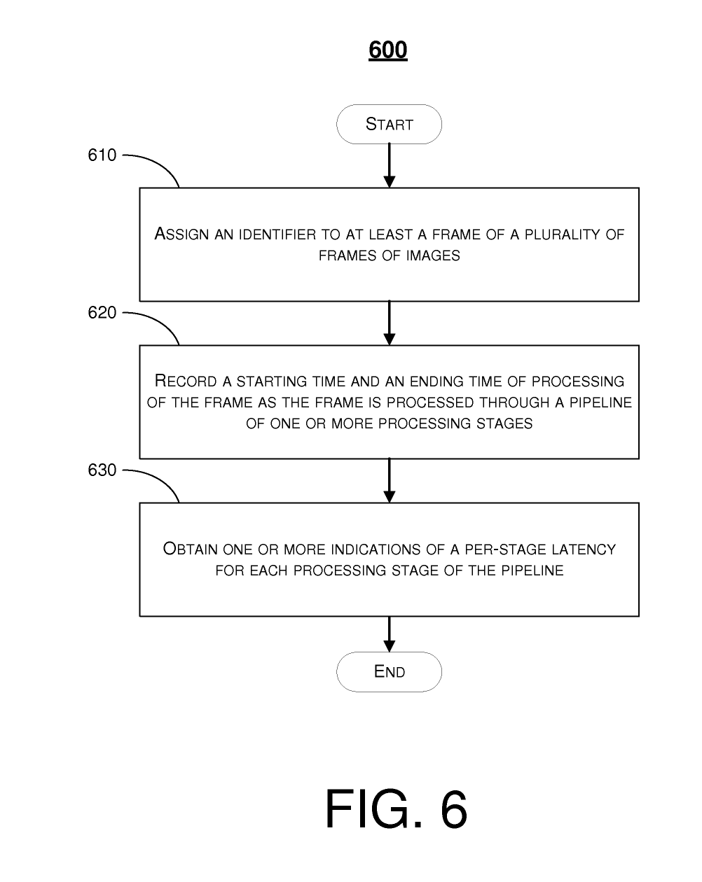

FIG. 6 is a flowchart of an example process 600 in accordance with another implementation of the present disclosure. Example process 600 may include one or more operations, actions, or functions as represented by one or more of blocks 610, 620 and 630. Although illustrated as discrete blocks, various blocks may be divided into additional blocks, combined into fewer blocks, or eliminated, depending on the desired implementation. Example process 600 may be implemented by latency profiling mechanism 120 of example framework 100, one or more components of example apparatus 300, and/or or one or more components of example apparatus 400. For illustrative purposes, the operations described below are performed by latency profiling mechanism 120 of example framework 100. Example process 600 may begin at block 610.

Block 610 (Assign an identifier to at least a frame of a plurality of frames of images) may refer to latency profiling mechanism 120 assigning a respective identifier to each of one or more frames of a plurality of frames of images.

Block 620 (Record a starting time and an ending time of processing of the frame as the frame is processed through a pipeline of one or more processing stages) may refer to latency profiling mechanism 120 recording a starting time and an ending time of processing of each of the one or more frames as each of the one or more frames is processed through a pipeline of one or more processing stages of an image processing device.

Block 630 (Obtain one or more indications of a per-stage latency for each processing stage of the pipeline) may refer to latency profiling mechanism 120 obtaining one or more indications of a per-stage latency for each processing stage of the pipeline of one or more processing stages.

In some implementations, example process 600 may further involve latency profiling mechanism 120 determining whether there is a condition related to the per-stage latency for at least one processing stage of the pipeline of one or more processing stages. In some implementations, the condition may include a fluctuation in frame rate through the one or more processing stages of the pipeline, an increase in processing time through the one or more processing stages of the pipeline, or both.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
monitoring at least one attribute associated with each of one or more frames of images by tracking a respective identifier of each of the one or more frames as each of the one or more frames is processed through a first pipeline of one or more processing stages of an image processing device; and
obtaining one or more indications related to one or more performance indices in the first pipeline of one or more processing stages based at least in part on the monitoring of the at least one attribute.

2. The method of claim 1, wherein the monitoring the at least one attribute associated with the one or more frames comprises obtaining different values of the at least one attribute respectively corresponding to the different stages of the one or more processing stages of the first pipeline.

3. The method of claim 1, further comprising:
monitoring at least one attribute associated with a respective duplicate frame of each of the one or more frames by tracking a respective identifier of the respective duplicate frame as the respective duplicate frame is processed through a second pipeline of one or more processing stages of the image processing device.

4. The method of claim 1, wherein the at least one attribute associated with each of the one or more frames comprises a respective timestamp paired with the respective identifier of each of the one or more frames, a respective checksum value which varies after being processed by each processing stage, or both.

5. The method of claim 4, wherein the respective timestamp paired with the respective identifier of each of the one or more frames indicates a starting time and an ending time of processing of a respective frame.

6. The method of claim 1, wherein the one or more performance indices in the first pipeline of one or more processing stages comprise a per-stage latency for each processing stage of the one or more processing stages of the first pipeline.

7. The method of claim 1, further comprising:
embedding the respective identifier in metadata associated with each of the one or more frames.

8. The method of claim 1, further comprising:
determining whether there is a condition related to the one or more performance indices in the first pipeline of one or more processing stages.

9. The method of claim 8, wherein the condition related to the one or more performance indices in the first pipeline of one or more processing stages comprises a fluctuation in frame rate through the one or more processing stages of the first pipeline, an increase in processing time through the one or more processing stages of the first pipeline, or both.

10. The method of claim 8, further comprising:
adjusting at least one processing stage of the one or more processing stages of the first pipeline in response to determining that there is the condition related to the one or more performance indices in the first pipeline of one or more processing stages.

11. The method of claim 1, further comprising:
providing data of one or more results of the monitoring, the obtaining, or both the monitoring and the obtaining to a display device which displays the one or more results.

12. The method of claim 8, further comprising:
providing data of one or more results of at least one of the monitoring, the obtaining, or the determining to a display device which displays the one or more results.

13. A method, comprising:
assigning a respective identifier to each of one or more frames of a plurality of frames of images;
recording a starting time and an ending time of processing of each of the one or more frames as each of the one or more frames is processed through a pipeline of one or more processing stages of an image processing device; and
obtaining one or more indications of a per-stage latency for each processing stage of the pipeline of one or more processing stages.

14. The method of claim 13, further comprising:
determining whether there is a condition related to the per-stage latency for at least one processing stage of the pipeline of one or more processing stages.

15. The method of claim 13, wherein the condition comprises a fluctuation in frame rate through the one or more processing stages of the pipeline, an increase in processing time through the one or more processing stages of the pipeline, or both.

16. An apparatus, comprising:
a memory unit configured to store data therein; and
a processing unit coupled to the plurality of processing modules and the memory unit, the processing unit configured to perform operations comprising:
monitoring at least one attribute associated with each of the one or more frames by tracking a respective identifier of each of the one or more frames as each of the one or more frames is processed through a first pipeline of one or more processing stages; and
obtaining one or more indications related to one or more performance indices in the first pipeline of one or more processing stages based at least in part on a result of the monitoring.

17. The apparatus of claim 16, wherein, in monitoring the at least one attribute associated with the one or more frames, the processing unit is configured to obtain different values of the at least one attribute respectively corresponding to the different stages of the one or more processing stages of the first pipeline.

18. The apparatus of claim 16, wherein the processing unit is further configured to monitor at least one attribute associated with a respective duplicate frame of each of the one or more frames by tracking a respective identifier of the respective duplicate frame as the respective duplicate frame is processed through a second pipeline of one or more processing stages.

19. The apparatus of claim 16, wherein the at least one attribute associated with each of the one or more frames comprises a respective timestamp paired with the respective identifier of each of the one or more frames, a respective checksum value which varies after being processed by each processing stage, or both.

20. The apparatus of claim 19, wherein the respective timestamp paired with the respective identifier of each of the one or more frames indicates a starting time and an ending time of processing of a respective frame.

21. The apparatus of claim 16, wherein the one or more performance indices in the first pipeline of one or more processing stages comprise a per-stage latency for each processing stage of the one or more processing stages of the first pipeline.

22. The apparatus of claim 16, wherein the processing unit is further configured to embed the respective identifier in metadata associated with each of the one or more frames.

23. The apparatus of claim 16, further comprising:
a monitoring unit coupled to the plurality of processing modules, the memory unit and the processing unit, the monitoring unit configured to determine whether there is a condition related to the one or more performance indices in the first pipeline of one or more processing stages.

24. The apparatus of claim 23, wherein the condition related to the one or more performance indices in the first pipeline of one or more processing stages comprises a fluctuation in frame rate through the one or more processing stages of the first pipeline, an increase in processing time through the one or more processing stages of the first pipeline, or both.

25. The apparatus of claim 23, wherein the monitoring unit is further configured to adjust at least one processing stage of the one or more processing stages of the first pipeline in response to determining that there is the condition related to the one or more performance indices in the first pipeline of one or more processing stages.

26. An apparatus, comprising:
a memory unit configured to store data therein; and
a processing unit coupled to the plurality of processing modules and the memory unit, the processing unit configured to perform operations comprising:
assigning a respective identifier to each of one or more frames of images;
storing, in the memory unit, data of a starting time and an ending time of processing of the one or more frames for each processing stage of a pipeline of one or more processing stages formed by the processing modules; and
receiving an indication that there is a condition related to one or more performance indices in the pipeline.

27. The apparatus of claim 26, further comprising:
an analysis device external to the apparatus and coupled to the memory unit or a monitoring unit inside the apparatus and coupled to the memory unit, the analysis device or the monitoring unit configured to analyze the data stored in the memory unit to determine that there is the condition related to one or more performance indices in the pipeline of one or more processing stages.

28. The apparatus of claim 27, wherein, in determining that there is the condition related to one or more performance indices in the pipeline of one or more processing stages, the analysis device or the monitoring unit is configured to determine a per-stage latency for each processing stage of the pipeline of one or more processing stages.

29. The apparatus of claim 27, wherein the analysis device or the monitoring unit is further configured to adjust one or more processing stages of the pipeline of processing stages in response to determining that there is the condition related to one or more performance indices in the pipeline of one or more processing stages.
